(19) United States
(12) Patent Application Publication
(10) Pub. No.: US 2001/0051323 A1
(43) Pub. Date: Dec. 13, 2001

(54) Convection-type brazing method and its apparatus for metal workpieces

(75) Inventor: Makoto Nishimura, Tokyo (JP)

Correspondence Address: BROWDY AND NEIMARK, P.L.L.C., 624 NINTH STREET, NW, SUITE 300, WASHINGTON, DC, 20001-5303, US

(73) Assignee: OAK NIPPON CO. LTD., Tokyo (JP)

(21) Appl. No.: 09/865,555

(22) Filed: May 29, 2001

(30) Foreign Application Priority Data
May 30, 2000 (JP) 2000-159615

(51) Int. Cl. F27D 3/00

(52) U.S. Cl. 432/11; 432/18; 432/128

(57) ABSTRACT

A metal workpiece to which a brazing material and a flux are previously adhered is set into an index type convection furnace, and a heating medium gas is blown to this metal workpiece, so that the temperatures of the workpiece are increased up to the brazing temperature. After that, the temperatures of the heating medium gas are varied between the temperature slightly higher than the brazing temperature and the temperature at least 5% lower than that, in a predetermined period, while brazing. According to this method, a temperature slope of the workpiece is eliminated and uniform brazing is possible.

### BACKGROUND OF THE INVENTION

1. Field of the Invention

The present invention relates to a method for brazing metal workpieces, using a convection furnace (a thermal convection furnace) to braze metal workpieces such as aluminum, copper, copper alloys, iron and stainless steel; and its apparatus. More particularly, the present invention relates to a method for brazing aluminum parts, using an index-type (intermittent motion) convection furnace to braze large-size aluminum workpieces of heat exchangers or the like for automobiles.

2. Description of the Related Arts

A convection furnace used for brazing large-size aluminum workpieces of heat exchangers for automobiles is, in general, composed of a combustion furnace wherein a heating medium gas comprising a heated inactive gas such as a nitrogen gas or the like is circulated within the furnace by a fan or the like, thus fixed in a heating chamber or heating a workpiece moving thereto.

The convection furnace used for brazing aluminum is disclosed in, for example, U.S. Pat. No. 5,195,673, which describes that a heating medium gas that has been heated with a heating device is circulated within the furnace, and a workpiece horizontally disposed in the furnace is heated and thus brazed by a flow of the heating medium gas flowing from an upside to a downside.

However, according to the furnace disclosed in U.S. Pat. No. 5,195,673, since the heating medium gas is blown from unidirectionally with respect to the workpiece, differences in temperatures are generated at places that the heating medium gas reaches and the other places, thus causing a problem that brazing quality would be deteriorated by this phenomenon.

Furthermore, in order to improve the productivity of this furnace, the flow rate of the heating medium gas is increased so as to increase the heating rate of the workpiece. However, when the flow rate of the heating medium gas is excessively increased, an eddy flow of the heating medium gas is generated on a surface of the workpiece to suppress the temperature rising at this portion, then a temperature slope occurs in the workpiece, thus causing thermal strain, and resulting in brazing failure.

In order to solve the above-mentioned problems, the present inventors have proposed in U.S. Pat. No. 5,660,543 an apparatus that realizes a uniform temperature over a workpiece by alternatively blowing a heating medium gas bidirectionally with respect to the workpiece. Although according to this apparatus, the surface temperature slope of the workpiece is smaller than in the conventional apparatus wherein the heating medium gas flows from unidirectionally, a stereo-temperature slope is still found present in the workpiece.

### SUMMARY OF THE INVENTION

In order to solve the above-mentioned problems, the first object of the present invention is to provide a method for convectively brazing a metal workpiece by using a convection furnace to allow uniform heating of the workpiece made of a metal such as aluminum, copper, iron or the like so as to prevent deformation of the workpiece and also shorten a heating time, thus improving operating efficiency.

The second object of the present invention is to provide a furnace for convectively brazing a metal workpiece by which the productivity may be improved due to the shortening of an operating time needed for brazing the workpiece made of a metal such as aluminum, copper, iron or the like, and which allows uniform heating of the workpiece to increase a product yield.

As results of intensive researches in order to make the present invention for overcoming the above-mentioned problems, the present inventors have found that during the operation of using a convection furnace to braze a workpiece made of a metal such as aluminum, copper, copper alloys, iron, stainless steel, or the like, slight variation of the heating medium gas temperature at a certain period after the workpiece reaches its brazing temperature is effective for eliminating the temperature slope in the metal workpiece, especially large-size metal workpieces.

Specifically, the method of convectively brazing a metal workpiece according to the present invention is characterized in comprising the steps of: setting the metal workpiece with a brazing material and flux previously attached thereto in an index-type convection furnace; blowing a heating medium gas from at least unidirectionally against the metal workpiece to raise temperatures of the workpiece to a brazing temperature; and performing uniform heating and brazing while varying the temperatures of the heating medium gas within a range between a temperature slightly higher than the brazing temperature and a temperature at least 5% lower than the brazing temperature at a predetermined period after the metal piecework has reached the brazing temperature.

Furthermore, in order to promote thermal uniformity of the metal workpiece, the method for convectively brazing a metal workpiece according to the present invention is characterized in that, in a uniform heating and brazing step, the heating medium gas is blown against the metal workpiece from at least two directions which are sequentially switched, and that brazing is carried out while the temperature of the heating medium gas is varied within a range between a temperature slightly higher than the brazing temperature and a temperature at least 5% lower than the brazing temperature at a predetermined period.

The brazing temperature is different depending on the kinds of metal materials, brazing materials and flux. In general, the brazing temperatures are 550° C. to 640° C. when a fluoride flux and aluminum of AA1000 series are used, and the brazing temperatures are 700° C. to 850° C. when copper and stainless steel are used.

For example, in the case of aluminum of AA1000, the brazing temperature is about 600° C. when AA4045 or AA4047 is used as the brazing material and a fluoride flux is used as flux. In a convection-type brazing furnace, a workpiece is generally heated to about 350° C. in a preheating furnace. The workpiece that has been transferred into the brazing furnace is heated rapidly by a heating medium gas that has been heated to about 610° C. to 620° C., thus the temperature of the workpiece is raised to 600° C. within several minutes.

In the prior art, the brazing material is molten by carrying on the heating while maintaining this temperature so as to carry out brazing. However, a temperature slope of 30° C. to 40° C. is still generated between a surface of the workpiece on which surface the heating medium gas directly attacks and the interior of the workpiece as well as the opposite surface of the workpiece even though the temperature of the heating medium gas is controlled to keep the furnace temperature to 600° C. As a result, the flow of the brazing material becomes non-uniform, and thus causing poor brazing quality.

For a conventional method wherein the heating medium gas is blown alternatively from both left and right sides in order to reduce the temperature slope, a problem still remained that the operation time has to be elongated in order to solve the temperature slope between the surface and the interior of the workpiece. For raising the interior temperature without elongating the operation time, the temperature of the heating medium gas has to be raised or the amount of the heating medium gas blown to the workpiece has to be increased. However, such the method is not preferable since the temperature of the workpiece surface is partially overheated, thus changing the properties of the material.

The present inventors have found that if the temperature of the heating medium gas is lowered in a short time at the point of time when the surface temperature of the workpiece rose, the temperature of the workpiece surface will lower and simultaneously heat on the surface migrates to a central portion due to heat conduction to naturally realize thermal uniformity through the whole workpiece. It was ascertained that, in order to fully exhibit this effect, the temperature of the heating medium gas may be varied for an extremely short period.

The variation range of the temperatures of the heating medium gas is defined, in terms of the temperature of the heating medium gas just before the heating medium distribution jet port, within a range between a temperature slightly higher than the brazing temperature and a temperature at least 5% lower than the brazing temperature. This temperature variation range is effective for improving thermal uniformity of the workpiece. For example, when the brazing temperature of aluminum is 600° C., the upper limit of the heating medium gas temperature is preferably set to 620° C. and the lower limit thereof is preferably set to 570° C. (i.e., 600° C.×95%) or lower.

The period for varying the temperature of the heating medium gas is 30 sec to 3 min, more preferably about 1 min. When the period is too short, the temperatures of the heating medium gas are difficult to lower to a desired temperature. On the other hand, when the period is too long, brazing unevenness is disadvantageously generated since the whole workpiece is kept at the lower limit of the temperature in a long time.

For copper or stainless steel, when the brazing temperature is, for example, 800° C., the upper limit of the temperature of the heating medium gas is preferably set to 820° C. and the lower limit thereof is preferably set to 760° C. (i.e., 800° C.×95%) or lower.

The apparatus according to the present invention is characterized in comprising: a heating chamber for using a heating medium gas to heat and braze a metal workpiece to which a brazing material and flux have previously been adhered; a thermal medium heating means for indirectly heating the heating medium gas; a gas transferring means for transferring the heating medium gas; a thermal medium distribution and injection means for blowing the heating medium gas that has been heated by the thermal medium heating means from at least unidirectionally against the metal workpiece; a thermal medium circulation path from the thermal medium heating means, through the gas transferring means, the thermal medium distribution and injection means and the heating chamber, and returning to the thermal medium heating means; and a heating medium gas temperature controlling means for controlling the temperature of the heating medium gas which is fed into the heating chamber from the thermal medium distribution and injection means, to vary within a range from a temperature slightly higher than a brazing temperature and a temperature at least 5% lower than the brazing temperature in a predetermined period. In a convectively brazing furnace of index type including an inactive gas supply route for supplying a lower-temperature inactive gas that serves as the heating medium gas to the thermal medium circulation path.

In the above-mentioned convectively brazing furnace of index type, at least two thermal medium distribution and injecting panel are provided as the thermal medium distribution and injection means for blowing the heating medium gas from different directions against the metal workpiece so as to improve thermal uniformity of the metal workpiece. Further, a heating medium gas supply switching device is provided for sequentially switching the supply of the heating medium gas to each of the thermal medium distribution and injection panels at a predetermined interval of time. Thus, during the uniform heating and brazing step, the temperatures of the heating medium gas are varied and simultaneously the blowing directions of the heating medium gas are periodically and sequentially switched from each other.

The low-temperature inactive gas used in the present invention is preferably a liquefied nitrogen gas or liquefied argon gas in views of their easy availability and low cost.

The gas transferring means may be a rotor blower or the like.

The means for indirectly heating the thermal medium may be a tube heater using fluid fuel as its heat source. The heating of the tube heat usually employs a gas burner using a fuel gas such as propane, while other burners using liquid fuel may also be used, surely.

In addition, the heating of the tube heater can also employ a hydrogen burner using a hydrogen gas and an oxygen gas. This hydrogen gas burner can easily feed a hydrogen gas and oxygen gas when it is attached to a water electrolyzation device. Furthermore, the hydrogen gas burner is preferable in view of air pollution prevention because it does not generate a fuel exhaust gas including a carbon dioxide, sulfur oxide, nitrogen oxide, dust, or the like.

Furthermore, the means for indirectly heating the thermal medium can employ an electric heater with an electrothermal source housed in the tube heater. A sheath heater is preferably used as this kind of electric heater.

The thermal medium distribution and injection means is provided for blowing the heating medium gas, which has been heated by the thermal medium heating means and transferred to the thermal medium distribution and injection means by the gas transferring means, from the periphery of the heating chamber onto the metal workpiece located within the heating chamber in the form of a uniform flow. In order to achieve this function, the thermal medium distribution and injection panels are typically used as the thermal medium distribution and injection means. In order to uniformly blow the heating medium gas to the surfaces of a plurality of stacked workpieces, the thermal medium distribution and injection panels are preferably formed as a louver-shaped barrier having a plurality of slits in transverse or longitudinal directions corresponding to the shape of the metal workpiece.

In the case of the cubic heating chamber, the thermal medium distribution and injection panels can arbitrarily be installed each on each face, namely in the range of 1 to 6 pieces. However, as a preferable embodiment, such a system is recommended that the thermal medium distribution and injection panels are disposed confronting each other so that the heating medium gas is blown from two right and left directions to a workpiece. Furthermore, in addition to this embodiment, the thermal medium distribution and injection panels may tri-directionally be disposed so that the heating medium gas is blown from downward.

The thermal medium distribution and injection panels can quadri-directionally or more be disposed, but when the heating medium gas is simultaneously blown from quadri-directionally or more, flows of each heating medium gas collide with each other at a central position of a workpiece, thereby hindering the flow of the heating medium gas to degenerate thermal efficiency, instead. Therefore, it is necessary that a measure of alternatively blowing the heating medium gas from the confronting thermal medium distribution and injection panels is devised.

In the case where the two thermal medium distribution and injection panels are provided confronting each other, it is preferable that they are disposed so that positions of slits of the two panels are slightly shifted. Namely, when the heating medium gas is simultaneously blown from the two thermal medium distribution and injection panels, in the case where the slits of the two panels are in the same position, the flows of both the heating medium gas collide with each other to generate an eddy current. This eddy current hinders a heat flow on the surface of the metal workpiece, leading to a cause of non-uniform heating of the workpiece.

Examples of the heating medium gas feeding path switcher include a slide valve which switches by individually operating or interlocking two ventilation ducts, a butterfly valve, and the like, and an ordinary switching valve used for switching a fluid flow path is usable.

As a means for controlling a heating energy supply amount of the thermal medium heating means, an operation control system which comprises: an operation control unit for increasing or decreasing the supply amount of thermal energy affixed to the heating medium gas in a predetermined period; and a correction control unit for controlling in feedback error in the operation control unit at temperatures of the heating medium gas to be fed into the heating chamber is used for the means.

The thermal energy affixed to the heating medium gas includes plus energy and minus energy. The plus energy is one for heating the heating medium gas, in other words, thermal energy to be applied on the thermal medium heating means, and specifically, thermal energy to be generated from a heat source for heating a tube heater.

When the feeding amount of fuel for heating the tube heater is increased or decreased periodically, temperatures of the heating medium gas can periodically be varied. More specifically, in the case of using a fluid burner, a travel of a switching valve of a fuel feeding tube has only to be controlled. In other words, two large and small values are established as the travel of the switching valve of the fuel feeding tube, and further a time of maintaining the travel large or small is determined. Then, the predetermined fuel is fed along its temporal axis, and in response thereto, the temperatures of the heating medium gas are varied.

Furthermore, when the temperatures of the heating medium gas are changed, one or both of the large and small travels of the switching valve of the fuel feeding tube have only to be changed. Additionally, by changing a time of maintaining the travel of the switching valve of the fuel feeding tube large or small or a ratio of the both also, its object can be attained. It is to be sure that the change of travel and the change of time may collectively be used.

When the electric heater is used for heating the tube heater, similarly, two large and small energization amounts of heating the tube heater are set to be between 0 and 100%, and a time of maintaining each setting value has only to be set.

As the minus energy, a low-temperature inactive gas which is a heating medium source is used. In other words, as brazing properties are deteriorated with an increase in a dew point within the brazing furnace, it is desirable that the dew point within the brazing furnace is ordinarily kept at (−)30° C. to (−)50° C. In order to keep the dew point within the brazing furnace at a setting temperature, the dry and fresh low-temperature inactive gas is replenished to the circulation path.

When the low-temperature inactive gas is liquified nitrogen, a nitrogen gas which is vaporized through an evaporator from a gas cylinder is preheated at about 100° C. in a preheat circuit, and then is replenished to the circulation path. As the temperatures of the nitrogen gas just before it is fed into the preheat circuit are about 30° C. to 50° C., when this lower-temperature nitrogen gas is direct fed into the circulation path, the temperatures of the heating medium gas can surely be lowered.

Accordingly, in the same manner as above, when the feeding amount of the low-temperature inactive gas to be replenished to the circulation path is controlled so as to increase or decrease periodically, the temperatures of the heating medium gas can periodically be varied. In order to so do, when the two large and small values are set as a travel of the switching valve of the fuel supply tube, and further the time of maintaining the travel large or small is set, the temperatures of the heating medium gas can periodically be varied. At this time, when a ventilation speed of the gas transferring means (blow) for circulating the heating medium gas within the furnace is raised, a cooling effect by the lower-temperature inactive gas can be further accelerated.

However, as thermal capacity of the circulating heating medium gas is actually large, even if the temperatures of the tube heater are lowered, in many cases, it is difficult to abruptly lower the temperatures of the heating medium gas. Therefore, when this way is used together with the method for increasing or decreasing the feeding amount of the lower-temperature inactive gas, it becomes possible to vary the temperatures of the heating medium gas in a short period.

In order to increase or decrease the supply amount of thermal energy affixed to the heating medium gas in a predetermined period, the operation control system is structured by a furnace temperature measuring sensor, and a programmable controller provided with a timer. For example, in the case of the tube heater, an electro-magnetic switching valve provided in the fuel supply path for a burner is turned on or off, or the travel is increased or decreased according to a time schedule, whereby the temperatures of the heating medium gas are varied.

Furthermore, when a sheath heater is used as the tube heater, the supply electricity is turned on or off, or an energization amount is increased or decreased according to the time schedule. Furthermore, in the case of the low-temperature inactive gas, the switching valve provided in the replenishing path is turned on or off, or the travel is increased or decreased according to the time schedule.

When the temperatures of the heating medium gas which are controlled by the operation control system are deviated from the predetermined temperatures, they are corrected by the correction control unit. This correction control unit is combined, in the case of the tube heater, with the electromagnetic valve for controlling the gas feeding amount of the heating burner and a control mechanism for controlling in feedback the electromagnetic valve in correspondence to the temperatures of the heating medium gas at the downstream of the thermal medium heating means. Furthermore, in the case of the sheath heater, the correction control unit is combined with the control mechanism for controlling in feedback the energization amount in correspondence to the temperatures of the heating medium gas at the downstream of the thermal medium heating means.

In the case of controlling the feeding amount of the inactive gas, the correction control unit is combined with the electromagnetic valve for controlling the feeding amount of the inactive gas and the control mechanism for controlling in feedback the electro-magnetic valve in correspondence to the temperatures of the heating medium gas at the downstream of the thermal medium heating means.

Furthermore, as the controlling means for controlling the heating energy supply amount of the thermal medium heating medium and/or the feeding amount of the inactive gas to be replenished to the thermal medium circulation path, the correction control unit for controlling in feedback a time of maintaining a high-temperature region and/or a time of maintaining a low-temperature region within each period controlled by the operation control system, in correspondence to temperatures of the heating medium gas at the downstream of the thermal medium heating means can also be used. At this time, when a ratio of the time of maintaining a high-temperature region to the time of maintaining a low-temperature region is controlled in feedback, the temperatures can be corrected without modifying a cycle time. Therefore, the control is preferable in step management.

In other words, the travel of the switching valve provided in the feeding tube of the fuel gas of the tube heater or the travel of the switching valve provided in the feeding tube of the inactive gas is set as two large and small values, and the ratio of the time of maintaining the travel large or small in each period is controlled in feedback in correspondence to temperatures of the heating medium gas at the downstream of the thermal medium heating means. In the case of the sheath heater, similarly, a ratio of times of turning-on or turning-off (or two high and low temperatures are established, and a ratio of the times of maintaining the temperatures) is controlled in feedback.

For example, when a period of varying the temperatures of the heating medium gas is 1 min and a ratio of the time of maintaining high temperatures to the time of maintaining low temperatures is originally set to 60:40, if the entire temperatures excessively rise, the ratio is set to 55:45, for example. By changing the ratio of the time of maintaining high temperatures to the time of maintaining low temperatures which is set in the timer also, the temperatures of the heating medium gas can be controlled.

### BRIEF DESCRIPTION OF THE DRAWINGS

FIG. 1 is a vertically sectional view of the entire device of a convectively brazing furnace according to an embodiment of the present invention;

FIG. 2 is a vertically sectional view of the brazing furnace showing a circulation state of a heating medium gas;

FIG. 3 is a vertically sectional view of the brazing furnace showing a state that a circulation direction of the heating medium gas of FIG. 2 is switched;

FIG. 4 is a transverse sectional view of a preheating furnace, a brazing furnace, and a cooling furnace;

FIG. 5 is an explanatory representation showing a change of surface temperatures of a workpiece at a preheating step and a brazing step;

FIG. 6 is an explanatory representation showing a feeding condition of a fuel gas of a tube heater at the preheating step and brazing step; and

FIG. 7 is an explanatory representation showing a replenishing condition of a nitrogen gas at the preheating step, brazing step and cooling step.

### DESCRIPTION OF THE PREFERRED EMBODIMENTS

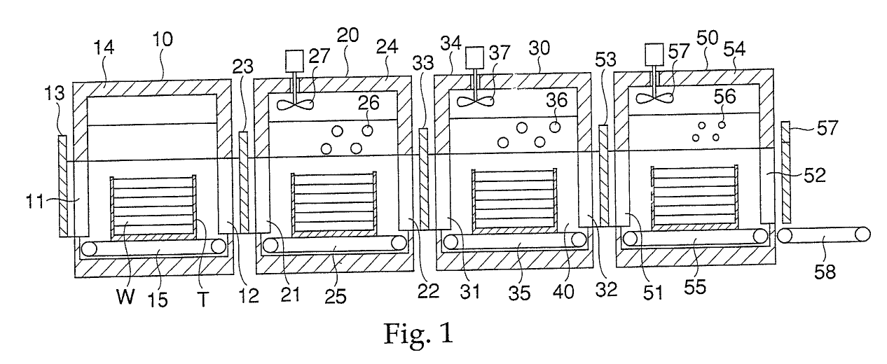

FIG. 1 shows an embodiment of a convection-type brazing furnace in the present invention, which is an index-type furnace provided successively with a drying furnace 10; a preheating furnace 20; a brazing furnace 30; and a cooling furnace 50.

The drying furnace 10 is structured by a furnace body 14 made of a stainless steel in which a refractory provided with shutters 13, 23 which vertically move at an inlet 11 and an outlet 12, respectively, is housed. Workpieces W in which parts in which a brazing material is clad have previously been incorporated into their bodies are stacked on a tray T, and are conveyed into the furnace by a belt conveyor 15 installed on a furnace floor. An inactive gas such as nitrogen or the like having a low dew point is blown into the drying furnace 10 via an introduction tube (not shown), and the workpieces W on which a flux is coated are dried.

A preheating furnace 20 is structured by a furnace body 24 made of a heat-resisting stainless steel in which a refractory provided with shutters 23, 33 which vertically move at an inlet 21 and an outlet 22, respectively, is housed. The workpieces W stacked on the tray T are conveyed from the drying furnace 10 to the preheating furnace 20 by a belt conveyor 25 installed on a furnace floor. The inactive gas such as nitrogen, or the like (heating medium gas) is circulated in the preheating furnace 20 by a fan 27. This heating medium gas is heated up to about 400 to 450° C. by a tube heater 26, and the temperatures of the workpieces are preheated up to about 350° C.

A brazing furnace 30 is structured by a furnace body 34 made of a heat-resisting alloy such as Inconel or the like in which a refractory provided with shutters 33, 53 which vertically move at an inlet 31 and an outlet 32, respectively, is housed. The workpieces W stacked on the tray T are conveyed from the preheating furnace 20 to the brazing furnace 30 by a belt conveyor 35 installed on a furnace floor. The heating medium gas is circulated in the brazing furnace 30 by a fan 37. With this heating medium gas which is heated up to about 610 to 620° C. by a tube heater 36, the temperatures of the workpieces are kept at the brazing temperatures of about 600° C., while brazing.

A cooling furnace 50 is structured by a furnace body 54 made of a stainless steel in which a refractory provided with shutters 53, 57 which vertically move at an inlet 51 and an outlet 52, respectively, is housed. The workpieces W which are stacked on the tray T and in which brazing operation is ended are conveyed into the cooling furnace 50 from the brazing furnace 30 by a belt conveyor 55 installed on a furnace floor. The dry air and the lower-temperature heating medium gas are circulated in the cooling furnace 50 by a fan 57, and decrease the temperatures of the workpieces. Reference numeral 56 denotes a water cooling tube, which decreases the temperatures of the heating medium gas and increases cooling efficiency of the workpieces. The cooled workpieces W are conveyed from the outlet 57 to the outside by a belt conveyor 58.

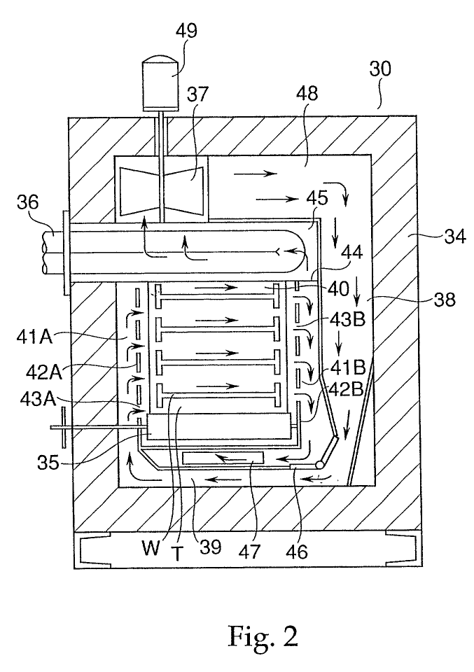

FIG. 2 shows a sectional view of the brazing furnace 30, and a heating chamber 40 for heating the workpiece is provided in a furnace core. The belt conveyor 35 for conveying the tray T mounting the workpiece W is installed in a lower part of the heating chamber 40. Plenums 41A, 41B for introducing the heating medium gas are provided on both sides of this heating chamber 40, and gas distribution and injection panels 42A, 42B provided with a plurality of slit gas injection ports 43A, 43B for blowing or flowing the heating medium gas in or out of the heating chamber 50 are provided between the plenums 41A, 41B and the heating chamber 40.

A switching valve 46 is provided at a boundary of a side duct 38 and a lower duct 39, and a flow of the gas can be switched. Namely, when the switching valve is at a position of FIG. 2, the heating medium gas fed out from the fan 37 provided in an uppermost part of the furnace passes an upper duct 48 and the side duct 38, and reaches the plenum 41A from the lower duct 39, and is blown into the heating chamber 40 from the gas injection port 43A to heat the workpieces. After that, the heating medium gas is exhausted from the gas injection port 43B on the opposite side to the plenum 41B, and passes a duct 47, and reaches a heating medium gas heating chamber 45, and is again heated by the tube heater 36, and is sucked in the fan 37. Reference numeral 49 is a motor for the fan 37.

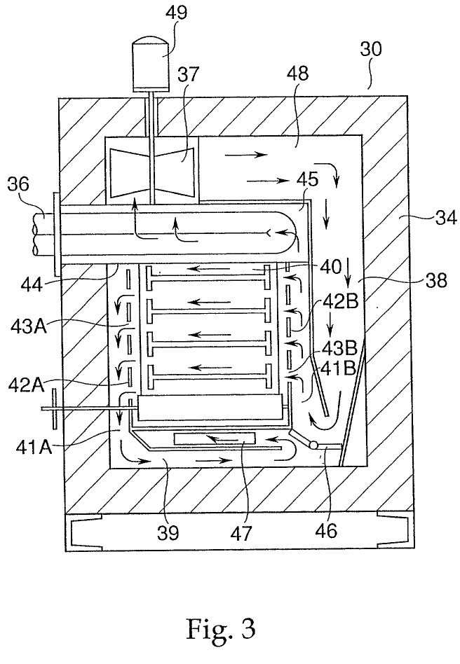

When the switching valve 46 is switched to a position of FIG. 3, the heating medium gas coming out from the fan 37 passes the upper duct 48 and the side duct 38, and flows into the plenum 41B, and is blown into the heating chamber 40 from the gas injection port 43B. After the heating medium gas heats the workpieces, it is exhausted from the gas injection port 43A on the opposite side to the plenum 41A, and passes the lower duct 39 and the duct 47, and reaches the heating medium gas heating chamber 45, and is again heated by the tube heater 36, and is sucked in the fan 37.

Incidentally, in the case of an operation method in which the heating medium gas is simultaneously blown in from both right and left sides without switching between right and left in blowing of the heating medium gas, the switching valve 46 is half opened, and also a shutter (not shown) provided in a barrier 44 between the heating chamber 40 and the heating medium gas heating chamber 45 is opened, and a switching valve (not shown) of the duct 47 is closed, so that the heating medium gas is blown in from the gas injection ports 43A, 43B on both the right and left sides. After the heating medium gas which is blown into the heating chamber 40 heats the workpiece from both the sides, it passes through the shutter of the barrier 44, and is circulated into the heating medium gas heating chamber 45.

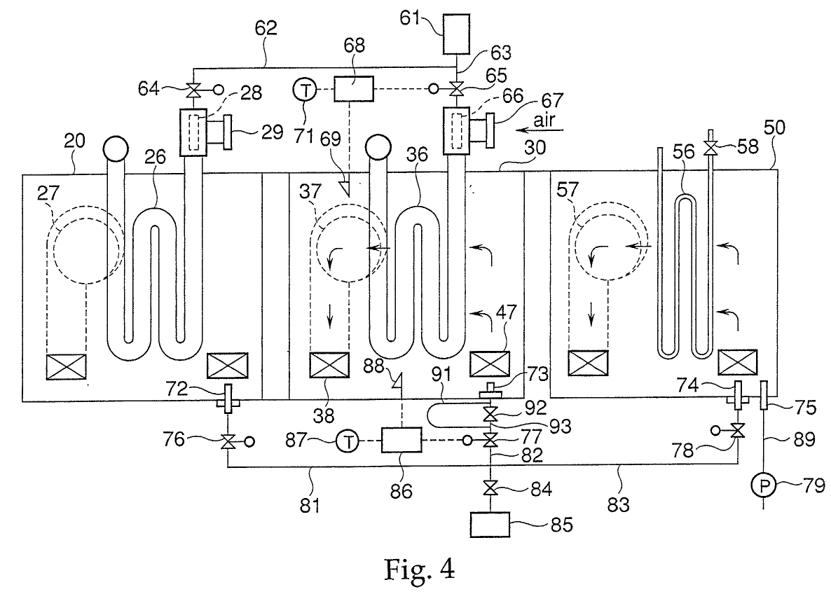

FIG. 4 is a transversely sectional view showing a part of each heating medium gas heating chamber of the preheating furnace 20, brazing furnace 30 and cooling furnace 50, and fans 27, 37, 59 are provided in each furnace, respectively. Furthermore, snaking tube heaters 26, 36 are provided in the preheating furnace 20 and brazing furnace 30, respectively. A snaking cooling water tube 56 is provided in the cooling furnace 50. Reference numeral 58 denotes a switching valve of a cooling water tube.

The gas burner 28 is provided in the interior of an inlet of the tube heater 26 of the preheating furnace 20, and propane as fuel is fed from a fuel gas source 61 via a pipe 62 and an electromagnetic valve 64. Reference numeral 29 is an air intake.

A gas burner 66 is provided in the interior of an inlet of the tube heater 36 of the brazing furnace 30, and propane is fed from the fuel gas source 61 via a pipe 63 and an electromagnetic valve 65. Reference numeral 67 is an air intake.

Reference numeral 68 denotes a programmable controller provided with a sensor 69 and a timer 71, and a travel of the electromagnetic valve 65 is controlled according to the time schedule preset by the operation control unit incorporated into this controller. When the temperatures of the heating medium gas detected by the sensor 69 are deviated with respect to a setting value, the correction control unit incorporated in the controller 68 can correct the setting value set in the controller 68 in correspondence to the detected temperatures.

Reference numeral 85 denotes a gas cylinder of a liquified nitrogen as the heating medium gas, and a nitrogen gas is fed into the preheating furnace 20 via a switching valve 84, a pipe 81, an electromagnetic switching valve 76, and a nozzle 72. The nitrogen gas is fed into the brazing furnace 30 via the gas cylinder 85, the switching valve 84, a pipe 82, an electro-magnetic switching valve 77, a preheat circuit 91, and a nozzle 73. Reference numeral 92 denotes a switching valve for switching a pipe 93 for direct connecting the pipe 82 with the nozzle 73.

The nitrogen gas is fed into the cooling furnace 50 via the gas cylinder 85, the switching valve 84, a pipe 83, an electromagnetic switching valve 78, and a nozzle 74. Reference numeral 75 denotes an air blowing nozzle, and a cooling air is led into the cooling furnace 50 via a pump 79 and a pipe 89.

Reference numeral 86 denotes a programmable controller provided with a sensor 88 and a timer 87, and a travel of the electromagnetic valve 77 is controlled according to the time schedule preset by the operation control unit which is incorporated into this controller. When the temperatures of the heating medium gas detected by the sensor 88 are deviated with respect to a predetermined value, the correction control unit incorporated in the controller 86 can correct the setting value set in the controller 86 in correspondence to the detected temperatures.

### Brazing Method

As shown in FIG. 1, an aluminum fin on both surfaces of which a brazing material is clad is incorporated in an aluminum flat tube, and the workpieces W on which a flux is coated are stacked on the tray T at a few steps, and the nitrogen gas is blown within the drying furnace 10 to dry. Next, they are conveyed to the preheating furnace 20 by the belt conveyors 15, 25. Here, the workpieces W are preheated up to about 350° C. with the nitrogen gas which is the heating medium gas heated by the tube heater 26.

The preheated workpiece is conveyed into the brazing furnace 30 by the belt conveyors 25, 35. Here, the workpieces W are heated up to the brazing temperature of about 600° C. with the heating medium gas which is heated by the tube heater 36. When the temperature of the workpieces reaches the brazing temperature, a uniformly heating process in which the temperatures of the heating medium gas are frequently varied is performed, while brazing.

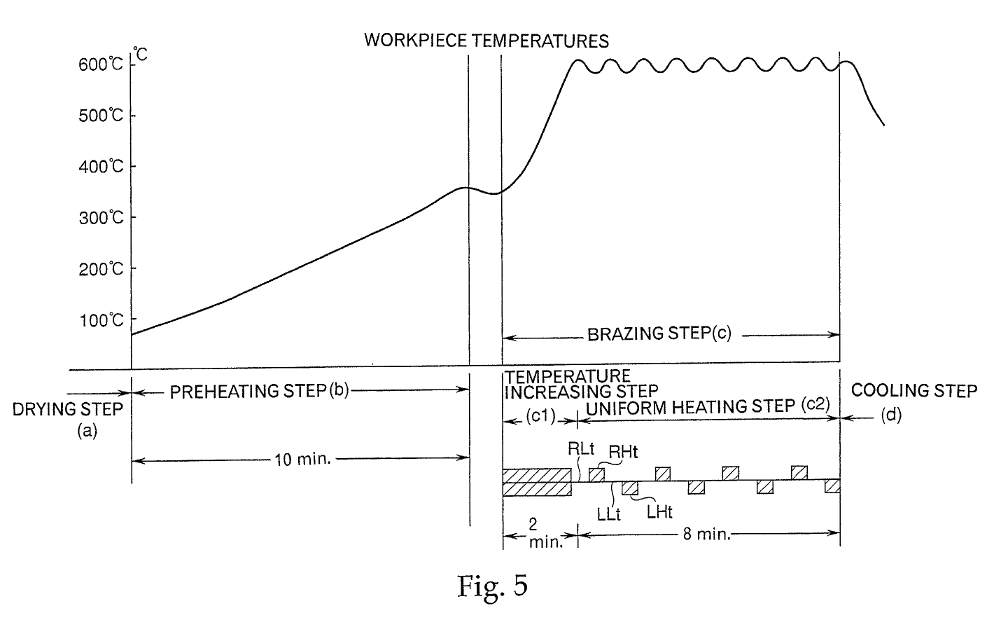

FIG. 5 shows an embodiment in the case where the heating medium gas is alternatively blown in from both right and left directions of the workpiece conveyed into the brazing furnace. When a process time at each step is set to 10 min, the workpiece is dried at a drying step a, so that the temperatures thereof increase slightly, and the workpiece is heated until the surface temperatures thereof come to approximately 350° C. at preheating step b.

The workpiece is transferred from the preheating furnace to the brazing furnace, so that the temperatures thereof reduce slightly, and the workpiece is transferred to a brazing step (c) in the brazing furnace. At a temperature increasing step (c1) in first 2 min, the heating medium gas is blown in from both the right and left directions to heat.

When the temperatures of the workpiece reach about 600° C., transfer to a uniformly heating step (c2). When the furniture temperature detected by the sensor 69 reaches the setting value, a start timing at the uniformly heating step is instructed by the programmable controller 68. At this step, a blowing direction of the heating medium gas is changed at a 1-min interval according to the time schedule input previously into the controller 68, and also the temperatures of the heating medium gas are varied during this 1 min. In other words, the heating medium gas is blown in from right in the first 1-min, but the low-temperature heating medium gas (about 560° C.) is blown in first 20 sec during this (right low-temperature period: RLt), and the high-temperature heating medium gas (about 615° C.) is blown in next 40 sec (right high-temperature period: RHt).

Next, the blowing direction of the heating medium gas is changed to left, and the low-temperature heating medium gas (about 560° C.) is blown in the first 20 sec (left low-temperature period: LLt), and the high-temperature heating medium gas (about 620° C.) is blown in next 40 sec (left high-temperature period: LHt). In this manner, the blowing direction of the heating medium gas is switched right and left alternatively, and also the temperatures of the heating medium gas are varied in each period.

In this manner, for varying the temperatures of the heating medium gas, a method for increasing or decreasing the supply amount of fuel of the tube heater, a method for increasing or decreasing an amount of the low-temperature heating medium gas to be replenished to the brazing furnace, and a method for changing a temporal ratio of a low-temperature period to a high-temperature period in the uniformly heating step are used. These methods can be carried out singly or in combination of the two methods or more.

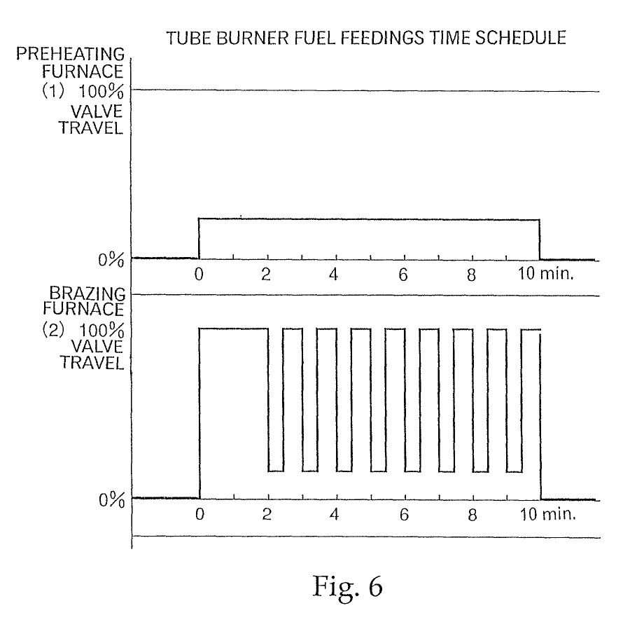

FIG. 6 shows a switching operation of the fuel-supplying electro-magnetic valve of the tube heater, and (1) shows the case of the preheating furnace and (2) shows the case of the brazing furnace.

In the preheating furnace (1), a travel of the fuel supplying switching valve 64 of the tube heater 26 is throttled to about 30%, and the fuel gas of a fixed amount is fed into the burner 28.

In the brazing furnace (2), a travel of the fuel supplying switching valve 65 of the tube heater 36 is entirely opened in first 2 min, and after that, the low-temperature period is set to 20 sec and the high-temperature period is set to 40 sec, and the electro-magnetic valve 65 is alternatively switched. In this operation, the electromagnetic valve 65 is mechanically switched according to a program set in the controller 68.

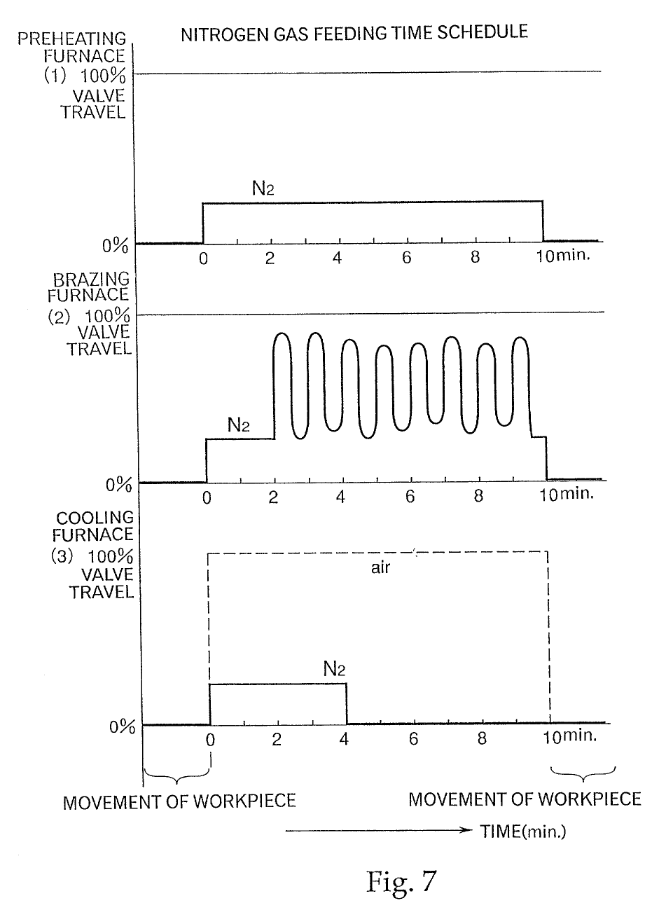

FIG. 7 shows a feeding state of a nitrogen gas, and (1) shows the preheating furnace, (2) shows the brazing furnace, and (3) shows the cooling furnace.

In the preheating furnace (1), the electro-magnetic valve 76 provided in the nitrogen gas feeding pipe 81 is throttled at all times to about 20%, so that the nitrogen gas is replenished into the preheating furnace.

In the brazing furnace (2), the electromagnetic valve 77 provided in the nitrogen gas feeding pipe 82 is throttled at all times to about 20 to 30% to replenish the nitrogen gas, which moreover passes the preheating circuit 91, and is heated at about 100° C. to be fed into the circulation path. When entering into the uniformly heating step, the switching valve 92 is first released, so that the nitrogen gas which passes the electro-magnetic valve 74 passes the pipe 93 and is direct fed into the nozzle 73. In conformity to the supply of fuel of the tube heater 36, the electromagnetic valve 77 is switched.

As the temperatures of the nitrogen gas which does not pass the preheating circuit 91 are about 35 to 50° C., this low-temperature nitrogen gas performs the auxiliary function of a means for lowering the temperatures of the heating medium gas due to a reduction in the specific burnup of the tube heater. Furthermore, the feeding amount of the nitrogen gas is controlled in feedback by use of the controller 86 in correspondence to the temperatures of the heating medium gas at the downstream of the tube heater 36 detected by the sensor 8, to finely adjust the temperatures of the heating medium gas.

In the cooling furnace (3), the travel of the nitrogen gas feeding switching valve 78 is throttled to 20% in first 4 min, to feed the nitrogen gas, so as to cool using together an air, and after that, cooling is performed with only an air which passes the pipe 89 by the pump 79 and is blown in from the nozzle 75.

### Operation Examples

Apparatus: Index-type convection furnace stringing the preheating furnace, brazing furnace, and cooling furnace.

Brazing furnace: Inner diameter 1200 mm×1200 mm×1200 mm

Heating system: Propane gas burner housed tube heater

Workpiece: Assembly of an AA3003 aluminum fin in which an AA4045 silicon alloy is clad on an AA1100 aluminum radiator part

Flux: Fluoride flux

Preheat temperature: 350° C.±50° C.

Brazing temperature: 600° C.±10° C.

Upper limit of the heating medium gas at the brazing step: 615° C.

Lower limit thereof: 560° C.

Cycle time: 1 min

Ratio of time of maintaining in high-temperature region and low-temperature region: 60:40

Brazing time (piling-up in the brazing furnace): 15 min

Inferior incidence (actual results of 2000 workpieces): 0.3% or less

### Conventional Method

Brazing time when not carrying out pulse heating: 30 min

Inferior incidence (actual results of 2000 workpieces): about 3%

Effects of the invention are as follows.

(1) In the index-type convection furnace, the uniformly heating and brazing step is formed in which, after the workpiece reaches the brazing temperature, the temperatures of the heating medium gas are varied in the predetermined period within a range between the temperature slightly higher than the brazing temperature and the temperature at least 5% lower than that, while brazing. Therefore, it is possible to prevent a deterioration of material quality due to overheating of the surface of the workpiece, to dissolve a three-dimensional temperature slop of the workpiece to enhance brazing quality, to reduce a brazing operation time to ½ or less, and to enhance an energy saving effect.

(2) In the index-type convection furnace, the uniformly heating and brazing step is formed in which, after the workpiece made of a metal reaches the brazing temperature, when the heating medium gas is blown from at least bi-directionally with respect to the workpiece, the blowing directions of the heating medium gas are sequentially switched, and also the temperatures of the heating medium gas are varied in the predetermined period within a range between the temperature slightly higher than the brazing temperature and the temperature at least 5% lower than that, while brazing. Thus, it is possible to prevent a deterioration of material quality due to overheating of the surface of the workpiece, to more completely dissolve the three-dimensional temperature slop of the workpiece to contrive to enhance still more brazing quality, to reduce the brazing operation time to about ⅓, and to enhance an energy saving effect.

(3) As the means for varying the temperatures of the heating medium gas in the uniformly heating and brazing step, the operation control device which increases or decreases the heating energy supply amount of the thermal medium heating means in the predetermined period is adopted. Therefore, it is possible to control the temperatures of the heating medium gas without so modifying the existent device, and moreover with simple operation and excellent precision.

(4) As the means for varying the temperatures of the heating medium gas in the uniformly heating and brazing step, the operation control device which increases or decreases the feeding amount of the inactive gas to be replenished to the thermal medium circulation path in the predetermined period is adopted. Therefore, it is possible to control the temperatures of the heating medium gas without so modifying the existent device, and moreover with simple operation and excellent precision.

(5) As the corrector of the operation controller, the controller which controls in feedback the supply amount of thermal energy affixed to the heating medium gas in correspondence to the temperatures of the heating medium gas at the downstream of the thermal medium heating means is adopted. Therefore, it is possible to control the temperatures of the heating medium gas without so modifying the existent device, and moreover with simple operation and excellent precision.

(6) As the corrector of the operation controller, the controller which controls in feedback the ratio of the time of maintaining a high-temperature region to the time of maintaining the low-temperature region in each period in the operation controller, in correspondence to the temperatures of the heating medium gas at the downstream of the thermal medium heating means is adopted. Therefore, it is possible to control the temperatures of the heating medium gas without so modifying the existent device, and moreover with simple operation and excellent precision.

(7) As the convection furnace in the present invention is an index type, any of the drying furnace, preheating furnace, brazing furnace and cooling furnace are partitioned by a door and airtightly sealed, and the temperature management within the furnaces and the dew management are facilitated, and additionally, the temperatures of the heating medium gas are varied frequently. Therefore, the partial overheating of the workpieces and the temperature slope are lessened, and it disappears that the flux is locally overheated and flows out, and as a result, the use amount of flux is about ⅓ times that of a muffle furnace and moreover high quality brazing is possible.

What is claimed is:

1. A method of convectively brazing a metal workpiece, characterized in comprising the steps of: setting the metal workpiece with a brazing material and flux previously attached thereto in an index-type convection furnace; blowing a heating medium gas from at least unidirectionally against the metal workpiece to raise temperatures of the workpiece to a brazing temperature; and performing uniform heating and brazing while varying the temperatures of the heating medium gas within a range between a temperature slightly higher than the brazing temperature and a temperature at least 5% lower than the brazing temperature at a predetermined period after the metal piecework has reached the brazing temperature.

2. A method of convectively brazing a metal workpiece according to claim 1, characterized in that, in a uniform heating and brazing step, the heating medium gas is blown against the metal workpiece from at least two directions which are sequentially switched, and that brazing is carried out while the temperature of the heating medium gas is varied within a range between a temperature slightly higher than the brazing temperature and a temperature at least 5% lower than the brazing temperature at a predetermined period.

3. A method of convectively brazing a metal workpiece according to claim 1, characterized in that, in the uniform heating and brazing step, the period of varying the temperature of the heating medium gas within a range between a temperature slightly higher than the brazing temperature and a temperature at least 5% lower than the brazing temperature is set to be 30 sec to 3 min.

4. A furnace for convectively brazing a metal workpiece, characterized in comprising: a heating chamber for using a heating medium gas to heat and braze a metal workpiece to which a brazing material and flux have previously been adhered; a thermal medium heating means for indirectly heating the heating medium gas; a gas transferring means for transferring the heating medium gas; a thermal medium distribution and injection means for blowing the heating medium gas that has been heated by the thermal medium heating means from at least unidirectionally against the metal workpiece; a thermal medium circulation path from the thermal medium heating means, through the gas transferring means, the thermal medium distribution and injection means and the heating chamber, and returning to the thermal medium heating means; and a heating medium gas temperature controlling means for controlling the temperature of the heating medium gas which is fed into the heating chamber from the thermal medium distribution and injection means, to vary within a range from a temperature slightly higher than a brazing temperature and a temperature at least 5% lower than the brazing temperature in a predetermined period. In a convectively brazing furnace of index type including an inactive gas supply route for supplying a lower-temperature inactive gas that serves as the heating medium gas to the thermal medium circulation path.

5. A furnace for convectively brazing a metal workpiece according to claim 4, characterized in comprising an operation control system which serves as the heating medium gas temperature controlling means, and which comprises: an operation control unit for increasing or decreasing a supply amount of thermal energy affixed to the heating medium gas in a predetermined period; and a correction control unit for controlling in feedback error in the operation control unit at temperatures of the heating medium gas to be fed into the heating chamber.

6. A furnace for convectively brazing a metal workpiece according to claim 5, characterized in that the operation control unit uses a supply amount of fuel to a burner which is a heating source of the thermal medium heating means, as a variable of managing temperatures of the heating medium gas.

7. A furnace for convectively brazing a metal workpiece according to claim 5, characterized in that the operation controlling unit uses a supply amount of a power to an electric heater which is a heating source of the thermal medium heating means, as a variable of managing temperatures of the heating medium gas.

8. A furnace for convectively brazing a metal workpiece according to claim 5, characterized in that the operation control unit uses a supply amount of a lower-temperature inactive gas which is replenished to the thermal medium circulation path, as a variable of managing temperatures of the heating medium gas.

9. A furnace for convectively brazing a metal workpiece according to any one of claims 5, characterized in that the correction control unit is provided with a correction control function of controlling in feedback the supply amount of thermal energy affixed to the heating medium gas in correspondence to temperatures of the heating medium gas at a downstream of the thermal medium heating means.

10. A furnace for convectively brazing a metal workpiece according to any one of claims 5, characterized in that the correction control unit is provided with a correction control function of controlling in feedback a time of maintaining a high-temperature region and/or a time of maintaining a low-temperature region within each period of increasing or decreasing the supply amount of thermal energy affixed to the heating medium gas, in correspondence to temperatures of the heating medium gas at a downstream of the thermal medium heating means.

11. A furnace for convectively brazing a metal workpiece according to any one of claims 4, characterized in that, as the thermal medium distribution and injection means, at least two thermal medium distribution and injection panels for blowing the heating medium gas from different directions with respect to the metal workpiece are provided, and also a heating medium gas feeding path switcher for sequentially switching, at a predetermined time interval, the feeding of the heating medium gas into each thermal medium distribution and injection panel is provided.
